(19) United States
(12) Patent Application Publication
(10) Pub. No.: US 2023/0125127 A1
(43) Pub. Date: Apr. 27, 2023

(54) METHOD FOR PRODUCING METAL TITANIUM

(71) Applicants: KYOTO UNIVERSITY, Kyoto-shi (JP); IHI CORPORATION, Tokyo (JP)

(72) Inventors: Tetsuya UDA, Kyoto (JP); Yoshinobu KUNITOMO, Kyoto (JP); Akihiro KISHIMOTO, Kyoto (JP); Kazuhiro KUMAMOTO, Kyoto (JP); Akihiro SATO, Tokyo (JP); Yasushi DODO, Tokyo (JP); Takuya HASHIMOTO, Tokyo (JP); Akihiko YOSHIMURA, Tokyo (JP)

(73) Assignees: KYOTO UNIVERSITY, Kyoto-shi, Kyoto (JP); IHI CORPORATION, Tokyo (JP)

(21) Appl. No.: 18/087,718

(22) Filed: Dec. 22, 2022

Related U.S. Application Data
(62) Division of application No. 15/734,754, filed on Dec. 3, 2020.

(30) Foreign Application Priority Data
Jun. 6, 2018 (JP) 2018-108973

(51) Int. Cl. C22B 34/12

(52) U.S. Cl. CPC C22B 34/1277; C22B 34/1272; C22B 34/1295

(57) ABSTRACT

A metal titanium production apparatus includes: a reductor that subjects titanium tetrachloride to a reduction process in presence of bismuth and magnesium to obtain a liquid alloy containing titanium and the bismuth; a segregator that subjects the liquid alloy to a segregation process to obtain a precipitate; and a distillator that subjects the precipitate to a distillation process to obtain metal titanium, and the distillator sets an atmosphere so as to preferentially vaporize the bismuth attached to the precipitate and then sets the atmosphere so as to vaporize the bismuth forming the precipitate.

### CROSS REFERENCE TO RELATED APPLICATIONS

This patent application is a divisional application of co-pending U.S. application Ser. No. 15/734,754, filed on Dec. 3, 2020, which is a U.S. national stage application under 35 U.S.C. § 371 of International Patent Application No. PCT/JP2019/017638 filed on Apr. 25, 2019, which claims the benefit of foreign priority to Japanese Patent Application No. JP 2018-108973 filed on Jun. 6, 2018, the entire contents of all of which are incorporated by reference herein. The International Application was published in Japanese on Dec. 12, 2019, as International Publication No. WO 2019:235098 A1 under PCT Article 21(2).

### TECHNICAL FIELD

The present disclosure relates to an apparatus and a method for producing metal titanium.

Priority is claimed on Japanese Patent Application No. 2018-108973, filed Jun. 6, 2018, the content of which is incorporated herein by reference.

### BACKGROUND

Patent Document 1 shown below discloses a titanium production method by which titanium alloy can be efficiently obtained and by purifying the titanium alloy, metal titanium can be continuously produced (refined) at low cost. This production method includes, as essential steps, a step 1 (reduction step) of adding titanium tetrachloride (TiCl₄) to a mixture containing bismuth and magnesium to obtain liquid alloy of bismuth and titanium and a step 2 (distillation step) of subjecting the liquid alloy to a distillation process to remove components other than the titanium therefrom, and includes, as an auxiliary step, a step (segregation step) of segregating the liquid alloy between the steps 1 and 2 to separate a liquid part from a solid-liquid coexistence part in which solid and liquid coexist.

### DOCUMENT OF RELATED ART

### Patent Document

[Patent Document 1] Japanese Patent No. 6095374

### SUMMARY

### Technical Problem

Since a large amount of energy has to be input into the above distillation step (distillation process), in order to further reduce the production cost (refinement cost) of the metal titanium, the processing efficiency (distillation efficiency) of the distillation step (distillation process) has to be improved.

The present disclosure is made in view of the above circumstances, and an object is to further improve the processing efficiency (distillation efficiency) in a distillation process than that in the related art.

### Solution to Problem

In order to obtain the above object, a metal titanium production apparatus of a first aspect of the present disclosure includes: a reductor that subjects titanium tetrachloride to a reduction process in presence of bismuth and magnesium to obtain a liquid alloy containing titanium and the bismuth; a segregator that subjects the liquid alloy to a segregation process to obtain a precipitate; and a distillator that subjects the precipitate to a distillation process to obtain metal titanium, and the distillator sets an atmosphere so as to preferentially vaporize the bismuth attached to the precipitate and then sets the atmosphere so as to vaporize the bismuth forming the precipitate.

The metal titanium production apparatus of the first aspect of the present disclosure may further include a concentrator that separates the bismuth attached to the precipitate from the precipitate to obtain a concentrated intermetallic compound, and the distillator may subject the concentrated intermetallic compound to the distillation process instead of the precipitate.

In the metal titanium production apparatus of the first aspect of the present disclosure, the distillator may set the atmosphere for preferentially vaporizing the bismuth attached to the precipitate such that the precipitate becomes 800° C. or a temperature in its vicinity.

In the metal titanium production apparatus of the first aspect of the present disclosure, the distillator may set the atmosphere for vaporizing the bismuth forming the precipitate such that the precipitate becomes 1000° C. or a temperature in its vicinity.

In the metal titanium production apparatus of the first aspect of the present disclosure, the distillator may set the atmosphere for vaporizing the bismuth forming the precipitate such that the precipitate becomes 1100° C. or a temperature in its vicinity.

In the metal titanium production apparatus of the first aspect of the present disclosure, the distillator may set the atmosphere for vaporizing the bismuth forming the precipitate such that the precipitate becomes 1000° C. or a temperature in its vicinity and then may set the atmosphere for vaporizing the bismuth forming the precipitate such that the precipitate becomes 1100° C. or a temperature in its vicinity.

In the metal titanium production apparatus of the first aspect of the present disclosure, the distillator may heat the precipitate at a first temperature such that a structure of titanium contained in the precipitate obtained by the segregator is maintained and vaporization of bismuth from a surface of the precipitate is maintained by bismuth diffusing to the surface from an inside of the precipitate, and then may heat the precipitate at a second temperature higher than the first temperature.

A metal titanium production method of a second aspect of the present disclosure includes: a reduction step of subjecting titanium tetrachloride to a reduction process in presence of bismuth and magnesium to obtain a liquid alloy containing titanium and the bismuth; a segregation step of subjecting the liquid alloy to a segregation process to obtain a precipitate; and a distillation step of subjecting the precipitate to a distillation process to obtain metal titanium, and in the distillation step, an atmosphere around the precipitate is set so as to preferentially vaporize the bismuth attached to the precipitate and then is set so as to vaporize the bismuth forming the precipitate.

In the metal titanium production method of the second aspect of the present disclosure, in the distillation step, the precipitate may be heated at a first temperature such that a structure of titanium contained in the precipitate obtained through the segregation step is maintained and vaporization of bismuth from a surface of the precipitate is maintained by bismuth diffusing to the surface from an inside of the precipitate, and then may be heated at a second temperature higher than the first temperature.

### Effects

According to the present disclosure, the processing efficiency (distillation efficiency) in a distillation process can be further improved than that in the related art.

### BRIEF DESCRIPTION OF DRAWINGS

FIG. 1 is a system configuration diagram of a metal titanium production apparatus of an embodiment of the present disclosure.

FIG. 2 is a flowchart showing operations of the metal titanium production apparatus of the embodiment of the present disclosure.

FIG. 3 is a Bi—Ti dual-system phase diagram of the embodiment of the present disclosure.

FIG. 4 is an enlarged photograph showing the shape of a porous structure of the embodiment of the present disclosure.

FIG. 5 is a graph showing the interrelationship between temperature profiles and titanium contents of the embodiment of the present disclosure.

### DESCRIPTION OF EMBODIMENTS

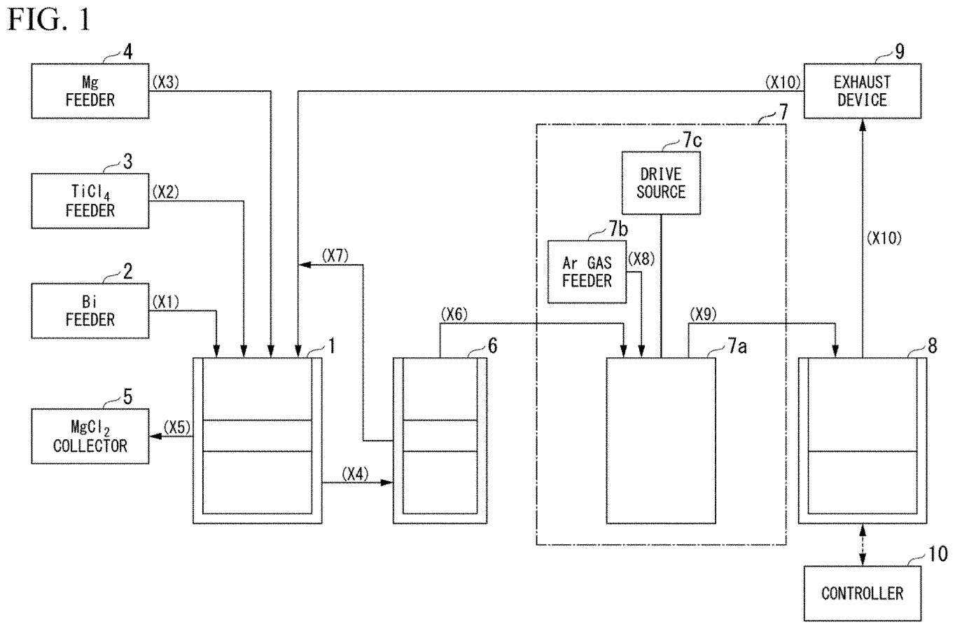

Hereinafter, an embodiment of the present disclosure will be described with reference to the drawings. As shown in FIG. 1, a metal titanium production apparatus of this embodiment includes a reduction furnace 1, a Bi feeder 2, a TiCl₄ feeder 3, a Mg feeder 4, a MgCl₂ collector 5, a segregator 6, a concentrator 7, a distillator 8 and an exhaust device 9.

Of these components, the reduction furnace 1, the Bi feeder 2, the TiCl₄ feeder 3, the Mg feeder 4 and the MgCl₂ collector 5 configure a reductor of the present disclosure. That is, the reduction furnace 1, the Bi feeder 2, the TiCl₄ feeder 3, the Mg feeder 4 and the MgCl₂ collector 5 correspond to a device that, as an overall function, subjects titanium tetrachloride (TiCl₄) X2 to a reduction process in the presence of bismuth (Bi) X1 and magnesium (Mg) X3 to obtain a liquid alloy (Bi—Ti liquid alloy X4) containing titanium (Ti) and bismuth (Bi).

The reduction furnace 1 is a heating furnace that subjects the titanium tetrachloride to the reduction process in the presence of the bismuth X1 and the magnesium X3 at a temperature (reduction temperature) higher than both of the melting points of the bismuth X1 and the magnesium X3 to produce the Bi—Ti liquid alloy X4 and magnesium chloride (MgCl₂) X5. The above reduction temperature is, for example, 900° C. The reduction temperature may be adjusted as appropriate. In the reduction furnace 1 whose temperature is set to the above reduction temperature, the titanium tetrachloride X2 in liquid state is added to the bismuth X1 and the magnesium X3 in liquid state, and thereby the Bi—Ti liquid alloy X4 in liquid state and the magnesium chloride X5 in liquid state are produced. The reduction furnace 1 supplies one product, i.e., the Bi—Ti liquid alloy X4, to the segregator 6 and supplies another product. i.e., the magnesium chloride X5, to the MgCl₂ collector 5.

The Bi feeder 2 is a bismuth supply source that supplies the reduction furnace 1 with the bismuth X1 that is one of raw materials for the above reduction process. The TiCl₄ feeder 3 is a titanium tetrachloride supply source that supplies the reduction furnace 1 with the titanium tetrachloride X2 that is another of the raw materials for the above reduction process. The Mg feeder 4 is a magnesium supply source that supplies the reduction furnace 1 with the magnesium X3 that is another of the raw materials for the above reduction process. The MgCl₂ collector 5 is a device that collects the magnesium chloride X5 that is another of the products from the reduction furnace 1.

The segregator 6 is a device that subjects the Bi—Ti liquid alloy X4 to a segregation process to obtain a solid-liquid mixture. That is, the segregator 6 holds the Bi—Ti liquid alloy X4 at a predetermined segregation temperature, for example, 500° C., and thereby selectively precipitates out a Bi—Ti liquid alloy (Ti₈Bi₉ liquid alloy) whose titanium concentration is higher than that of the Bi—Ti liquid alloy X4 to produce a solid-liquid mixture containing a Ti₈Bi₉ intermetallic compound (solid phase, a precipitate) and a bismuth alloy X7 (liquid phase) having a high bismuth concentration. The segregator 6 supplies a mixture X6 of the solid-liquid mixture containing a relatively large amount of Ti₈Bi₉ to the concentrator 7 and supplies the bismuth alloy X7 of the solid-liquid mixture to the reduction furnace 1. In the mixture X6 obtained by the segregator 6, bismuth (solid or liquid) is attached or contained between Ti₈Bi₉ crystals (solid).

The concentrator 7 is a device that separates, from the mixture X6, the bismuth attached to the mixture X6 to obtain a concentrated intermetallic compound X9. As shown in FIG. 1, the concentrator 7 includes at least a concentration furnace 7a, an Ar gas feeder 7b and a drive source 7c. The concentration furnace 7a is a cylindrical container with a bottom that stores the mixture X6 and holds it in a predetermined atmosphere, the concentration furnace 7a being installed in a posture in which its axis is in the vertical direction.

The concentration furnace 7a includes a perforated drum storing the mixture X6, a receiving container housing the perforated drum, a heater provided in the receiving container, a heat insulation member and the like. The perforated drum included in the concentration furnace 7a is rotatable by the drive source 7c.

The Ar gas feeder 7b is a device that supplies Ar gas X8 to the concentration furnace 7a. The Ar gas feeder 7b supplies the Ar gas X8 to the concentration furnace 7a to make the inside of the concentration furnace 7a have an Ar gas atmosphere (inert gas atmosphere). The drive source 7c is a rotational power source for rotating the mixture X6 in the concentration furnace 7a. That is, the drive source 7c rotationally drives the perforated drum housed in the concentration furnace 7a to rotate the mixture X6 stored in the perforated drum.

The concentrator 7 having the above configuration applies centrifugal force to the mixture X6 by rotating the perforated drum while heating the mixture X6 stored in the perforated drum by the above heater under the Ar gas atmosphere. The concentrator 7 serves as a kind of centrifuge and performs solid-liquid separation to separate the bismuth in liquid phase from the Ti₈Bi₉ crystals in solid phase by applying the centrifugal force to the mixture X6. The concentrator 7 removes most of the bismuth in liquid phase from the mixture X6 through the centrifugation, obtains an alloy, that is, the concentrated intermetallic compound X9, having a higher titanium concentration than that of the mixture X6, and supplies it to the distillator 8. As is well known, the centrifugal force is a kind of inertial force.

The distillator 8 is a device that subjects the concentrated intermetallic compound X9 to a distillation process that is a kind of purification process to obtain metal titanium. That is, the distillator 8 selectively vaporizes the bismuth forming the concentrated intermetallic compound X9 by heating the concentrated intermetallic compound X9 to a predetermined distillation temperature under a pressure-decreased atmosphere to obtain the metal titanium. The above distillation temperature is, for example, 1000° C. The distillator 8 is a kind of purification device.

The exhaust device 9 is a vacuum pump that exhausts the internal gas of the distillator 8 to the outside. The exhaust device 9 supplies the reduction furnace 1 with bismuth X10 obtained by an exhaust process of the exhaust device 9. By the operation of the exhaust device 9, the inside of the distillator 8 becomes the pressure-decreased atmosphere.

The metal titanium production apparatus having the above configuration is comprehensively controlled by the controller 10. That is, each operation of the bi feeder 2, the TiCl₄ feeder 3, the Mg feeder 4, the MgCl₂ collector 5, the segregator 6, the concentrator 7, the distillator 8 and the exhaust device 9 is appropriately controlled by the controller 10 to perform a series of production steps as described later. The metal titanium production apparatus of this embodiment includes the controller 10.

The controller 10 is configured of a computer that includes a central processing unit (CPU), a storage device, an input/output device and the like. The storage device includes one or more of volatile memory such as random access memory (RAM), non-volatile memory such as read only memory (ROM), hard disk drive (HDD), solid state drive (SSD) and the like. The input/output device exchanges signals and data (measurement data such as temperature and pressure) with the bi feeder 2, the TiCl₄ feeder 3, the Mg feeder 4, the MgCl₂ collector 5, the segregator 6, the concentrator 7, the distillator 8 and the exhaust device 9 through wire or wireless. Although FIG. 1 shows that the controller 10 is connected only to the distillator 8 through wire or wireless for simplification, the controller 10 is connected to each device. The computer can perform a predetermined function based on a program or the like stored in the storage device. The controller 10 may be configured of computers provided in the bi feeder 2, the TiCl₄ feeder 3, the Mg feeder 4, the MgCl₂ collector 5, the segregator 6, the concentrator 7, the distillator 8 and the exhaust device 9.

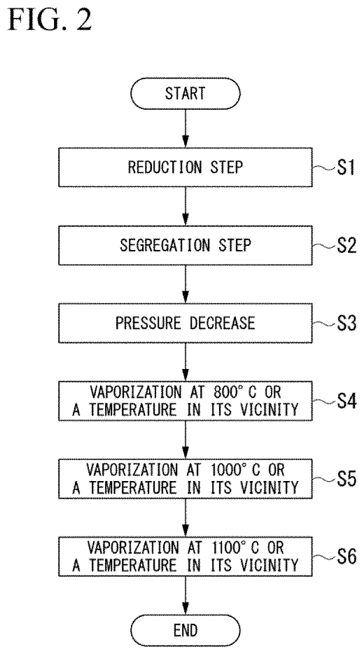

Next, the operation of the metal titanium production apparatus of this embodiment, that is, a metal titanium production method using the metal titanium production apparatus, will be described in detail with reference to FIG. 2 in addition to FIG. 1.

In the metal titanium production apparatus, first, a reduction step (reduction process) is performed by the reductor (step S1). That is, in the reductor, the atmospheric temperature in the reduction furnace 1 is set to a predetermined reduction temperature, the Bi feeder 2 supplies the bismuth X1 to the reduction furnace 1, the TiCl₄ feeder 3 supplies the titanium tetrachloride X2 to the reduction furnace 1, and the Mg feeder 4 supplies the magnesium X3 to the reduction furnace 1.

As a result, in the reduction furnace 1, the chemical reaction (reduction reaction) of the following formula (1) proceeds, and the Bi—Ti liquid alloy X4 containing titanium and bismuth and the magnesium chloride X5 are produced.

TiCl₄+Bi+2Mg→Bi-Ti+2MgCl₂ (1)

In the formula (1), “Bi—Ti” represents the Bi—Ti liquid alloy X4 containing the titanium and the bismuth. The supply amount of each raw material to be supplied to the reduction furnace 1, that is, the supply amount of each of the bismuth X1, the titanium tetrachloride X2 and the magnesium X3 to the reduction furnace 1, is appropriately set based on the molar ratio of each raw material in the reduction reaction shown in the above formula (1).

The Bi—Ti liquid alloy X4 and the magnesium chloride X5 exist as liquid in the reduction furnace 1 and are separated into two layers due to a difference in specific gravity therebetween. That is, the Bi—Ti liquid alloy X4 has a relatively large specific gravity and thus becomes a lower-layer liquid product in the reduction furnace 1. On the other hand, the magnesium chloride X5 has a relatively small specific gravity and thus becomes an upper-layer liquid product in the reduction furnace 1. The lower-layer Bi—Ti liquid alloy X4 is taken out from the bottom of the reduction furnace 1 and is supplied to the segregator 6, and the upper-layer magnesium chloride X5 is taken out from the middle part of the reduction furnace 1 and is collected by the MgCl₂ collector 5.

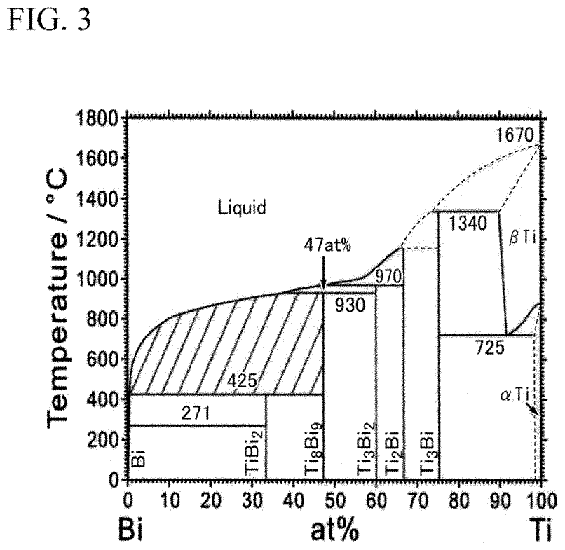

In the metal titanium production apparatus, a segregation step (segregation process) is subsequently performed by the segregator 6 (step S2). That is, the segregator 6 subjects the Bi—Ti liquid alloy X4 to the segregation process. As shown in the phase diagram of FIG. 3, in a case where the segregation temperature of the Bi—Ti liquid alloy X4 is 500° C. and the titanium concentration in the Bi—Ti liquid alloy X4 is 47 at % or less, a Ti₈Bi₉ intermetallic compound precipitates. Although the Ti₈Bi₉ intermetallic compound is obtained as the precipitate in the segregation step (the segregator 6) of this embodiment, the present disclosure is not limited to this, and the segregation temperature and the atomic composition percentage may be adjusted so as to obtain another Bi—Ti intermetallic compound (for example, Ti₃Bi₂) as the precipitate.

The Ti₈Bi₄ intermetallic compound is a precipitate of the Bi—Ti liquid alloy X4 and is a solid substance having a higher titanium concentration than that of the Bi—Ti liquid alloy X4. The Ti₈Bi₉ intermetallic compound has a lower density than that of the Bi—Ti liquid alloy X4 and thus rises in the Bi—Ti liquid alloy X4 to become a floating object. That is, in the segregator 6, the Bi—Ti liquid alloy X4 is exposed to a predetermined segregation temperature, and thereby a solid-liquid mixture (the mixture X6) containing the Ti₈Bi₉ intermetallic compound (solid phase) and bismuth (liquid phase) is produced.

In the concentrator 7, the bismuth (solid or liquid) attached to the Ti₈Bi₉ crystals (solid) of the mixture X6 is maintained in liquid state, the solid-liquid separation is performed by the action of centrifugal force, and an intermetallic compound having a higher titanium concentration than that of the mixture X6, that is, the concentrated intermetallic compound X9 that is a concentrate of the mixture X6, is obtained.

In the metal titanium production apparatus, a distillation step (distillation process) is subsequently performed using the distillator 8. That is, the distillator 8 places the concentrated intermetallic compound X9 at a predetermined distillation temperature and under a pressure-decreased atmosphere and thereby selectively vaporizes the bismuth forming the concentrated intermetallic compound X9 to obtain metal titanium.

Specifically, the metal titanium production apparatus first decreases in pressure the inside of the distillator 8 as the distillation step (step S3). That is, the metal titanium production apparatus causes the inside of the distillator 8 in which the concentrated intermetallic compound X9 is stored to be under a pressure-decreased atmosphere of, for example, 10 Pa or less by the exhaust device 9. The pressure in the distillator 8 may be appropriately adjusted.

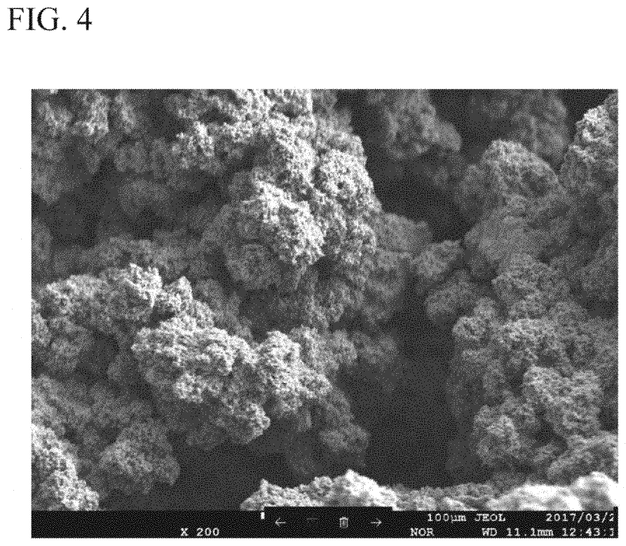

The metal titanium production apparatus increases the internal temperature of the distillator 8 to 800° C. or a temperature in its vicinity (first temperature) as the distillation step (step S4). By increasing the internal temperature of the distillator 8 to 800° C. or a temperature in its vicinity, the internal temperature of the concentrated intermetallic compound X9 gradually increases, and the bismuth attached to the concentrated intermetallic compound X9 begins to vaporize. That is, the distillator 8 sets an atmosphere (atmosphere around the precipitate) so as to preferentially vaporize the bismuth attached to the precipitate. The bismuth vaporized from the inside of the concentrated intermetallic compound X9 is released as gas from the surface of the concentrated intermetallic compound X9. At this time, the bismuth vaporizes at the surface (liquid surface) of the concentrated intermetallic compound X9, and thus a porous structure (refer to FIG. 4) is formed thereat. It is considered that the bismuth is released from the concentrated intermetallic compound X9 through the pores of the porous structure.

In other words, the distillator 8 (distillation step) of this embodiment heats the precipitate at a first temperature (in this embodiment, 800° C. or a temperature in its vicinity) such that the structure of the titanium contained in the precipitate (in this embodiment, the Ti₈Bi₉ intermetallic compound) obtained by the segregator 6 (segregation step) is maintained and the vaporization of bismuth from the surface of the precipitate is maintained by bismuth diffusing to the surface from the inside of the precipitate. During heating at the first temperature, the diffusion of bismuth to the surface from the inside of the precipitate continues, and thus even if the bismuth vaporizes from the surface of the precipitate, the content of the bismuth on the surface is appropriately maintained. In other words, it is possible to prevent titanium from becoming a film shape at the surface of the precipitate by the content of titanium at the surface increasing, and thus the diffusion of bismuth to the surface from the inside of the precipitate and the vaporization of bismuth from the surface are appropriately maintained. During heating at the first temperature, the titanium contained in the precipitate does not melt, the metal structure thereof can be maintained, and thus as the bismuth continues to vaporize from the precipitate, the precipitate gradually changes into a porous structure having a large number of pores. Through these pores, the diffusion and vaporization of the bismuth from the inside of the precipitate can be further facilitated. The first temperature may be appropriately adjusted according to the pressure and the like in the distillator 8.

The metal titanium production apparatus increases the internal temperature of the distillator 8 to 1000° C. or a temperature in its vicinity (second temperature) as the distillation step (step S5). That is, the distillator 8 sets the atmosphere so as to preferentially vaporize the bismuth attached to the precipitate as described above and then sets the atmosphere so as to vaporize the bismuth forming the precipitate. At this time, since the vapor pressure of bismuth is extremely higher than that of titanium, it is considered that the vaporization of bismuth is selectively facilitated from Ti₈Bi₉ in the concentrated intermetallic compound X9. Thereby, it is expected that the titanium concentration of the porous concentrated intermetallic compound X9 increases and thus the melting point thereof rises. Therefore, even under a condition exceeding 1000° C., while the strength of the structure is maintained without the structure melting or collapsing, the distillation of bismuth can be performed at a higher temperature.

In other words, after heating at the first temperature, the precipitate is further heated at a second temperature (in this embodiment, 1000° C. or a temperature in its vicinity, or 1100° C. or a temperature in its vicinity) higher than the first temperature. As described above, by the bismuth vaporizing from the precipitate, the content of the titanium in the precipitate increases, and thus the melting point of the precipitate is expected to rise. Therefore, even if the precipitate is heated at the second temperature higher than the first temperature, while the metal structure of the titanium contained therein is maintained, the diffusion of the bismuth to the surface from the inside of the precipitate and the vaporization thereof from the surface can be further facilitated. Consequently, the content of the bismuth in the precipitate can be effectively reduced. The second temperature may be appropriately selected according to an increase in the melting point of the precipitate.

The metal titanium production apparatus increases the internal temperature of the distillator 8 to 1100° C. or a temperature in its vicinity as the distillation step (step S6). Thereby, the distillator 8 finally vaporizes the bismuth contained in the concentrated intermetallic compound X9 to obtain metal titanium.

The bismuth (gas phase) acquired by the exhaust device 9 from the distillator 8 is supplied to the reduction furnace 1 as shown in FIG. 1. The bismuth (liquid phase) contained in the solid-liquid mixture in the segregator 6 is also supplied to the reduction furnace 1 as shown in FIG. 1.

As described above, in this embodiment, the bismuth attached to the concentrated intermetallic compound X9 is preferentially vaporized in the distillation step to form a porous structure at the surface of the concentrated intermetallic compound X9, and thereafter the bismuth contained in Ti₈Bi₉ is vaporized. Thereby, the bismuth vaporized thereinside can be released through the pores of the porous structure, and the processing efficiency (distillation efficiency) in the distillation process can be further improved than the related art.

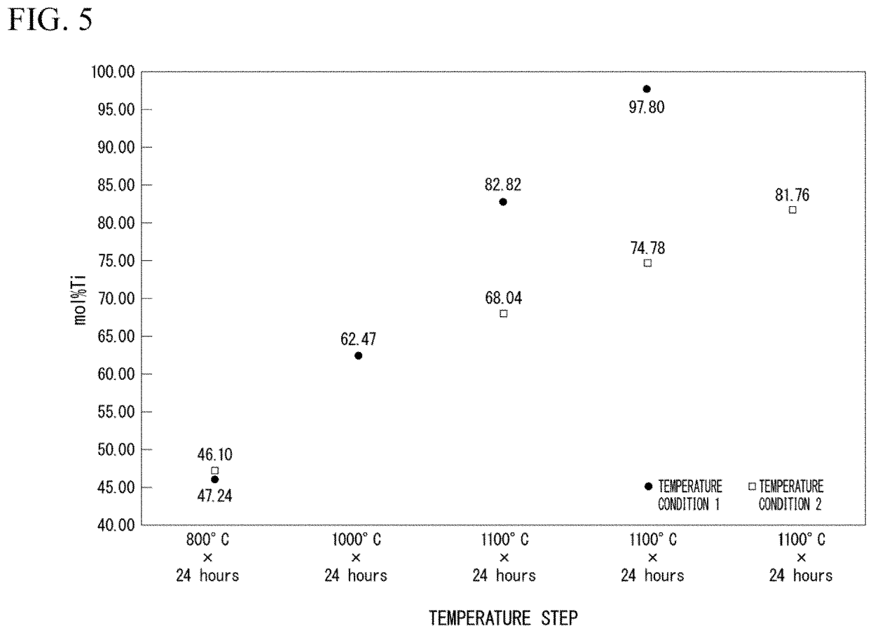

A graph is shown in FIG. 5 in which the titanium concentrations in steps when the above steps S4 to S6 were performed are designated as a temperature condition 1, and the titanium concentrations when distillation at 1100° C. was carried out three times without performing the step S5 are designated as a temperature condition 2. In this graph, under the temperature condition 1, the titanium concentration in the finally obtained metal was 97.80%, and under the temperature condition 2, the titanium concentration in the finally obtained metal was 81.76%. That is, by performing the step S5 in which distillation is carried out at 1000° C. the vaporization of the bismuth can be facilitated while preventing the collapse of the porous structure, and the purity of the titanium can be increased.

The present disclosure is not limited to the above embodiment, and for example, the following modifications can be considered.

(1) In the above embodiment, the metal titanium production apparatus includes the concentrator 7 that concentrates the mixture X6 by performing the solid-liquid separation thereon, but the present disclosure is not limited to this. The metal titanium production apparatus may not include the concentrator 7, and the distillator may directly distill the mixture X6.

(2) In the above embodiment, the metal titanium production apparatus includes the segregator 6 that produces the mixture X6 containing the Ti₈Bi₉ intermetallic compound (solid phase) and the bismuth (liquid phase) from the Bi—Ti liquid alloy X4, but the present disclosure is not limited to this. The metal titanium production apparatus may not include the segregator 6, and the distillator may directly distill the Bi—Ti liquid alloy X4.

(3) In the above embodiment, the concentrator 7 that applies centrifugal force (inertial force) to the mixture X6 is used, but the present disclosure is not limited to this. As another device configuration that applies mechanical inertial force to the mixture X6, for example, it is conceivable to stop the mixture X6 while moving it in a predetermined direction at a predetermined speed. In order to separate the bismuth in liquid phase from the mixture X6, a filtration device using a filter, a vacuum dehydrator, a belt press or the like may be used.

(4) In the above embodiment, the concentration temperature is set to, for example, 500° C., but the present disclosure is not limited to this. According to the phase diagram shown in FIG. 3, the concentration temperature may be within the range of 425° C. to 930° C. as the maximum range, and may be within the range of 425° C. to 700° C.

(5) In the above embodiment, in the distillator 8, the distillation temperature is changed to 800° C., 1000° C., and 1100° C. as an example, but the present disclosure is not limited to this. The distillation temperature may be changed depending on the situation.

That is, it is sufficient that the step S5 be set to a higher temperature than the step S4 and the step S6 be set to a higher temperature than the step S5. In the distillator 8 (distillation step) of the above embodiment, distillation is performed at three different temperatures, but distillation may be performed at two different temperatures or four or more different temperatures.

1-9. (canceled)

10: A metal titanium production method, comprising:
a reduction step of subjecting titanium tetrachloride to a reduction process in presence of bismuth and magnesium to obtain a liquid alloy containing titanium and the bismuth;
a segregation step of subjecting the liquid alloy to a segregation process to obtain a precipitate; and
a distillation step of subjecting the precipitate to a distillation process to obtain metal titanium,
wherein
in the distillation step, an atmosphere around the precipitate is set so as to preferentially vaporize the bismuth attached to the precipitate and then is set so as to vaporize the bismuth forming the precipitate, and
in the distillation step,
the precipitate is heated at a first temperature such that a structure of titanium contained in the precipitate obtained through the segregation step is maintained and vaporization of bismuth from a surface of the precipitate is maintained by bismuth diffusing to the surface from an inner part of the precipitate so that the precipitate changes into a porous structure and that the melting point of the precipitate increases due to the vaporization of bismuth, and
thereafter the precipitate is heated at a second temperature such that the structure of titanium contained in the precipitate having an increased melting point is maintained, the second temperature being higher than the first temperature.
